(19) United States
(12) Patent Application Publication
(10) Pub. No.: US 2026/0188922 A1
(43) Pub. Date: Jul. 2, 2026

(54) TERMINAL BLOCK

(71) Applicant: Yazaki Corporation, Tokyo (JP)

(72) Inventors: Takumi MIZOBE, Shizuoka (JP); Wataru HASEGAWA, Shizuoka (JP)

(73) Assignee: Yazaki Corporation, Tokyo (JP)

(21) Appl. No.: 19/424,941

(22) Filed: Dec. 18, 2025

(30) Foreign Application Priority Data
Dec. 26, 2024 (JP) 2024-230149

(51) Int. Cl. H01R 9/24

(52) U.S. Cl. CPC H01R 9/24

(57) ABSTRACT

A terminal block includes: a plurality of terminals; a housing including a main body portion that holds the plurality of terminals penetrating the main body portion in a connection direction, and a terminal support portion that is provided continuously with the main body portion; a front holder that supports ends of the plurality of terminals; and a water stop member that stops water at a water stop surface of the terminal support portion, the front holder including ribs that divide arrangement spaces of the plurality of terminals, and the ribs being formed to be raised from a side of arrangement positions of the terminals toward the water stop surface of the terminal support portion and having inclined surfaces inclined from the arrangement positions of the plurality of terminals toward the water stop surface.

### CROSS-REFERENCE TO RELATED APPLICATION(S

The present application claims priority to and incorporates by reference the entire contents of Japanese Patent Application No. 2024-230149 filed in Japan on December 26, 2024.

### BACKGROUND OF THE INVENTION

### Field of the Invention

The present invention relates to a terminal block.

### Description of the Related Art

Conventionally, as what is related to a terminal block, for example, as described in JP 2023 – 162655 A, there is known a terminal block including a plurality of terminals arranged side by side with respect to a fixing portion and a partition wall that divides the terminals.

In such a terminal block, there is room for improvement in that a water stop member is not easily assembled. For example, in the above-described terminal block, there is a case where an annular water stop member is assembled to the outer periphery of a housing (fixing portion) that holds the plurality of terminals to stop water. However, since the housing has the partition wall or the like formed thereon and its outer surface has irregularities, it is not easy to assemble the water stop member at a water stop position.

### SUMMARY OF THE INVENTION

Therefore, an object of the present invention is to provide a terminal block in which a water stop member can be easily assembled.

In order to achieve the above mentioned object, a terminal block according to one aspect of the present invention includes a plurality of terminals arranged side by side; a housing including a main body portion that holds the plurality of terminals penetrating the main body portion in a connection direction, and a terminal support portion that is provided continuously with the main body portion and extends in the connection direction; a front holder that is assembled to the terminal support portion and supports ends of the plurality of terminals; and a water stop member that is assembled to an outer periphery of the terminal support portion and stops water at a water stop surface of the terminal support portion, wherein the front holder includes ribs that are assembled to the terminal support portion on a distal end side of an assembly position of the water stop member and divide arrangement spaces of the plurality of terminals, and the ribs are formed by being raised from a side of arrangement positions of the terminals toward the water stop surface of the terminal support portion, and have inclined surfaces inclined from the arrangement positions of the plurality of terminals toward the water stop surface of the water stop member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a terminal block according to an embodiment;

FIG. 2 is an exploded perspective view of the terminal block according to the embodiment;

FIG. 3 is a front view of the terminal block according to the embodiment;

FIG. 4 is a cross-sectional view of the terminal block taken along line IV-IV in FIG. 3;

FIG. 5 is an explanatory view of assembly of the terminal block according to the embodiment; and

FIG. 6 is an explanatory view of a modification of the terminal block according to the embodiment.

### DETAILED DESCRIPTION OF THE PREFERRED EMBODIMENTS

Hereinafter, an embodiment according to the present invention will be described in detail with reference to the drawings. Incidentally, the present invention is not limited by the embodiment. In addition, constituent elements in the following embodiment include one that can be replaced by a person skilled in the art or substantially the same one.

### Embodiment

The present embodiment relates to a terminal block. In the following description, among a first direction, a second direction, and a third direction which intersect each other, the first direction is referred to as a "connection direction X", the second direction is referred to as a "width direction Y", and the third direction is referred to as a "height direction Z". Here, the connection direction X, the width direction Y, and the height direction Z are orthogonal to each other. Incidentally, the term "orthogonal" as used herein includes substantially orthogonal. The connection direction X corresponds to a connection direction between the terminal block and a connection target and a connection direction of a terminal. In addition, each direction used in the following description indicates a direction in a state where the respective parts are assembled to each other unless otherwise specified.

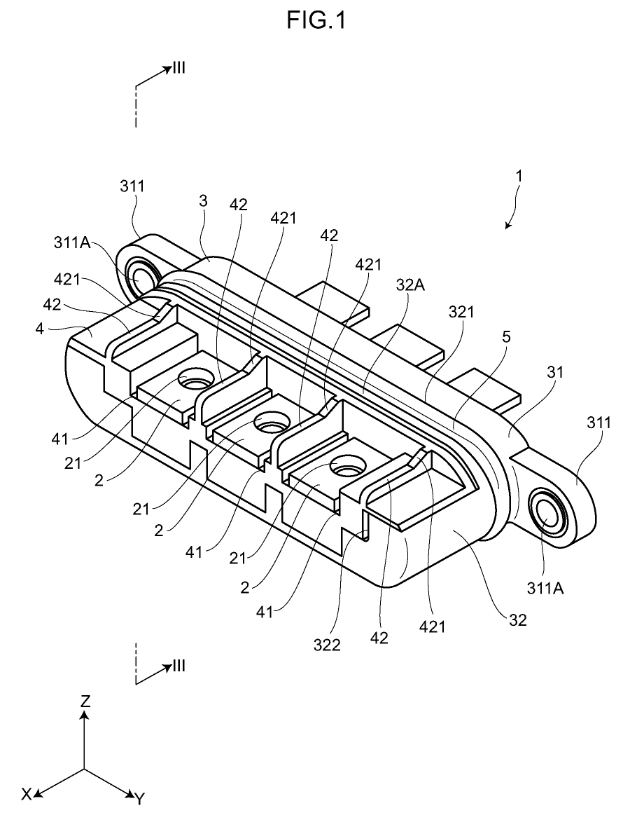

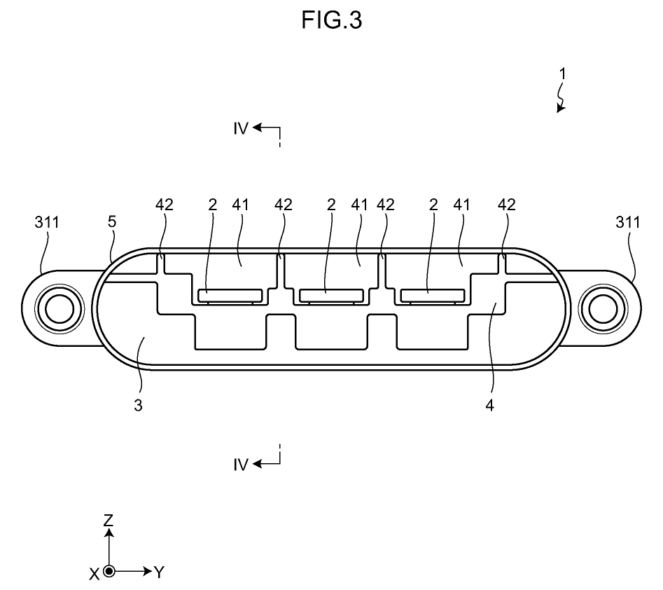

As illustrated in FIGS. 1 to 3, a terminal block 1 is a component that holds a terminal 2, and is attached to an attachment object (not illustrated), for example, and is used by being mounted on a vehicle. The terminal block 1 includes the terminal 2, a housing 3, a front holder 4, and a water stop member 5. The terminal 2 is a terminal fitting for electrical connection, and is formed by, for example, forming a conductive metal in a plate shape. A plurality of the terminals 2 are provided and arranged side by side in the width direction Y intersecting the connection direction X. The terminal 2 extends in the connection direction X and is arranged in a direction intersecting the height direction Z. For example, three terminals 2 are provided, but the number of terminals 2 installed is not limited thereto. A through hole 21 is formed at one end of the terminal 2 in the connection direction X. The through hole 21 is a hole through which a fastening member is inserted to fix the terminal 2 to the front holder 4. The terminal 2 is formed so as to extend linearly, but for example, may be bent from the connection direction X to the height direction Z, or may be bent back from the height direction Z to the connection direction X to be formed in a crank shape.

The housing 3 is a component that holds the terminal 2 and is attached to the attachment object, and is made of an insulating material, for example, resin. The housing 3 includes a main body portion 31 and a terminal support portion 32. The main body portion 31 is formed in a plate shape or a block shape, and is provided in a direction intersecting the connection direction X. The main body portion 31 is formed to be longer in the width direction Y than in the height direction Z, and holds the plurality of terminals 2 arranged side by side in the width direction Y and penetrating the main body portion 31 in the connection direction X. The main body portion 31 includes a flange 311. The flange 311 is a portion for fixing the housing 3 to the attachment object, and is provided at each of both ends of the main body portion 31 in the width direction Y. The flange 311 has a fixing hole 311A penetrating in the connection direction X.

The terminal support portion 32 is a portion that supports or fixes the terminal 2, and supports or fixes the terminal 2 via the front holder 4, for example. The terminal support portion 32 is provided continuously with the main body portion 31 and extends from the main body portion 31 in the connection direction X. The terminal support portion 32 is formed integrally with the main body portion 31, for example, and has an elliptical or oval cross-sectional shape in a direction intersecting the connection direction X. The terminal support portion 32 is formed to be longer in the width direction Y than in the height direction Z, for example, similarly to the main body portion 31.

The terminal support portion 32 forms a holding groove 321 and an assembling portion 322. The holding groove 321 is a groove for holding the water stop member 5, and is formed as an annular groove along the outer periphery of the terminal support portion 32. The holding groove 321 is formed to be closer to a proximal end of the terminal support portion 32 than the assembling portion 322. An outer peripheral surface 32A of the terminal support portion 32 is a water stop surface. The holding groove 321 is formed to have a size and a depth such that the water stop member 5 protrudes from the outer peripheral surface 32A in a state where the water stop member 5 is accommodated. Accordingly, the water stop member 5 appropriately stops water between the housing 3 and the attachment object. The assembling portion 322 is a recess for assembling the front holder 4, and is formed by recessing a distal end side of the terminal support portion 32 from the holding groove 321 along the outer shape of the front holder 4. The plurality of terminals 2 penetrating the main body portion 31 protrude from the assembling portion 322. For example, the assembling portion 322 is formed by recessing a half or more of the terminal support portion 32.

The front holder 4 is a member that is assembled to the terminal support portion 32 and supports an end of the terminal 2. The front holder 4 is made of an insulating material such as resin. The front holder 4 is assembled to the distal end side of the terminal support portion 32 with respect to an assembly position of the water stop member 5. That is, the front holder 4 is assembled to the assembling portion 322 of the terminal support portion 32. As described above, since the assembling portion 322 is formed to be closer to the distal end side of the terminal support portion 32 than the holding groove 321 that accommodates the water stop member 5, the front holder 4 assembled to the assembling portion 322 is installed on a distal end side of the water stop member 5.

The front holder 4 forms an arrangement space 41 in which each of the plurality of terminals 2 is arranged, and supports the ends of the plurality of terminals 2. The arrangement spaces 41 are spaces for arranging the terminals 2 extending through the main body portion 31, and are formed by being defined for the terminals 2, respectively, in the front holder 4. A side closer to the main body portion 31 of the arrangement space 41 in the connection direction X is divided by a side wall 411. An insertion hole 412 is formed in the side wall 411. The insertion hole 412 is a hole through which the terminal 2 is inserted. The terminal 2 extending from the main body portion 31 enters the arrangement space 41 through the insertion hole 412.

The arrangement spaces 41 adjacent to each other are divided by a rib 42. The rib 42 extends in the connection direction X, is raised in the height direction Z, and is provided between the arrangement space 41 and the arrangement space 41. The rib 42 divides the arrangement spaces 41 of the terminals 2 to improve the insulation property of the terminals 2. The rib 42 is formed to be raised from an installation position side of the terminal 2 toward the water stop surface of the terminal support portion 32. In addition, the rib 42 is provided not only between the arrangement spaces 41 and 41 but also outside the arrangement spaces 41 formed at end positions in the width direction Y. Since the ribs 42 are provided in this manner, the assemblability of the water stop member 5 can be further improved.

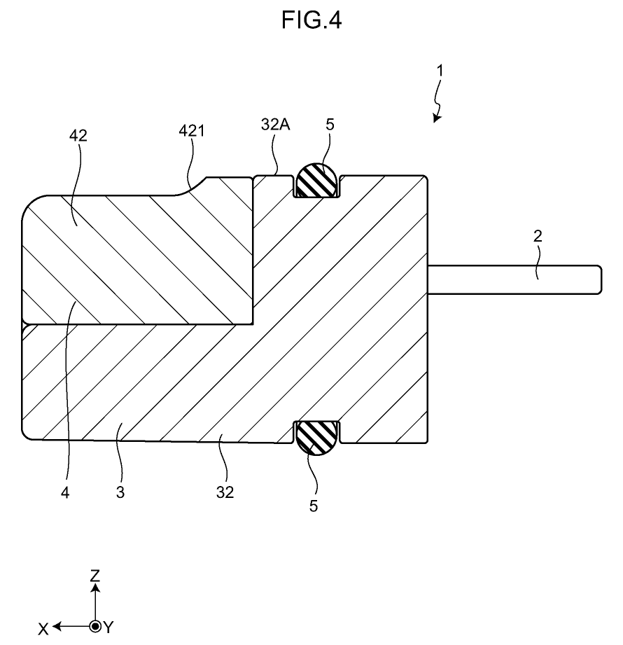

As illustrated in FIG. 4, the rib 42 forms an inclined surface 421. That is, the rib 42 forms the inclined surface 421 on a raised end surface in the height direction Z. The inclined surface 421 is inclined toward the water stop surface (outer peripheral surface 32A) from the distal end side toward the proximal end side of the terminal support portion 32. That is, the inclined surface 421 is inclined such that the rib 42 becomes higher from the distal end side to the proximal end side of the terminal support portion 32. For example, the end surface of the rib 42 extends straight from the distal end side to the proximal end side, and is formed to be inclined by the inclined surface 421. In the terminal block 1, since the inclined surface 421 is formed on the rib 42, the water stop member 5 can be easily assembled when the water stop member 5 is assembled to the holding groove 321 from the distal end side of the terminal support portion 32.

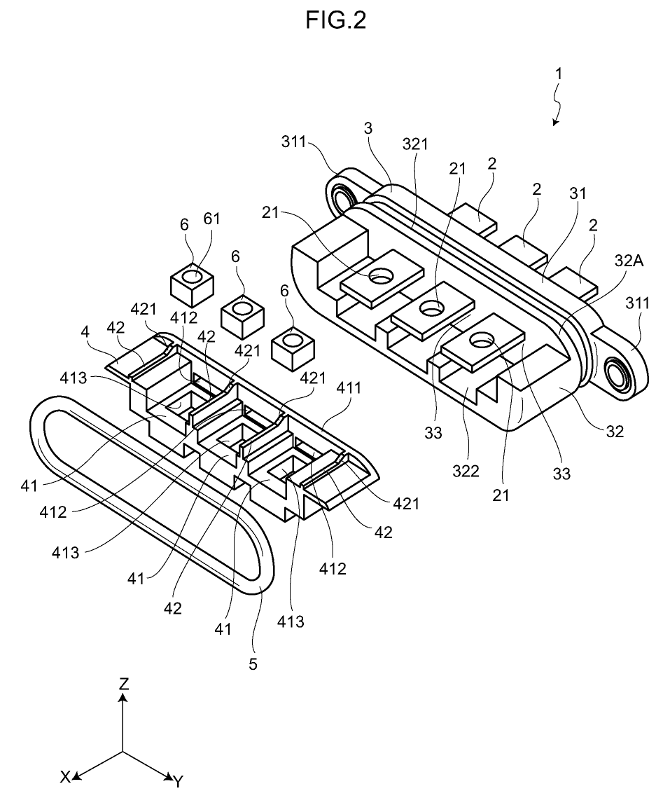

As illustrated in FIG. 2, an accommodating portion 413 is formed in the arrangement space 41 of the front holder 4. The accommodating portion 413 is a space portion for accommodating a nut 6, and is formed by recessing a floor of the arrangement space 41. The nut 6 has a threaded hole 61 having a thread on the inner peripheral surface. The accommodating portion 413 is formed at a position where the through hole 21 of the terminal 2 is located in the connection direction X and the width direction Y. The accommodating portion 413 is formed in a shape corresponding to the outer shape of the nut 6, and is formed to have, for example, a rectangular cross section.

Incidentally, the outer shape of the nut 6 and the shape of the accommodating portion 413 are not limited to those having a rectangular cross section. When the fastening member such as a bolt is inserted into the through hole 21 of the terminal 2 in a state where the nut 6 is accommodated in the accommodating portion 413 and screwed with the nut 6, the terminal 2 is fastened and fixed to the front holder 4 by fastening of the fastening member and the nut 6.

The water stop member 5 is a member that stops water between the housing 3 and the attachment object, and is assembled to the holding groove 321 of the housing 3. The water stop member 5 is an annular packing, and is made of, for example, an elastic member. For example, the water stop member 5 is assembled so as to surround the terminal support portion 32 from the distal end side with respect to the terminal support portion 32 to which the front holder 4 is assembled.

Next, assembling of the terminal block 1 according to the present embodiment will be described.

The terminal block 1 is assembled by sequentially performing assembly of the terminals 2 and the front holder 4 to the housing 3 and assembly of the water stop member 5 to the housing 3.

As illustrated in FIG. 2, first, the terminals 2 are assembled to the housing 3. The terminals 2 are assembled to the housing 3 so as to penetrate the main body portion 31. At this time, the terminals 2 are assembled such that the ends where the through holes 21 are formed are located on the terminal support portion 32 side.

Then, the front holder 4 is assembled to the housing 3. First, the nuts 6 are accommodated in the accommodating portions 413 of the front holder 4, and the front holder 4 is assembled to the assembling portion 322 of the terminal support portion 32 in a state where the nuts 6 are accommodated. At this time, the terminals 2 extending from the main body portion 31 are inserted into the insertion holes 412, and the front holder 4 is assembled to the assembling portion 322. Incidentally, the assembly to the housing 3 may be performed in the order of the front holder 4 and the terminals 2. Then, the fastening members are inserted into the through holes 21 of the terminals 2 and screwed into the threaded holes 61 of the nuts 6, whereby the terminals 2 are fixed to the front holder 4 and the housing 3.

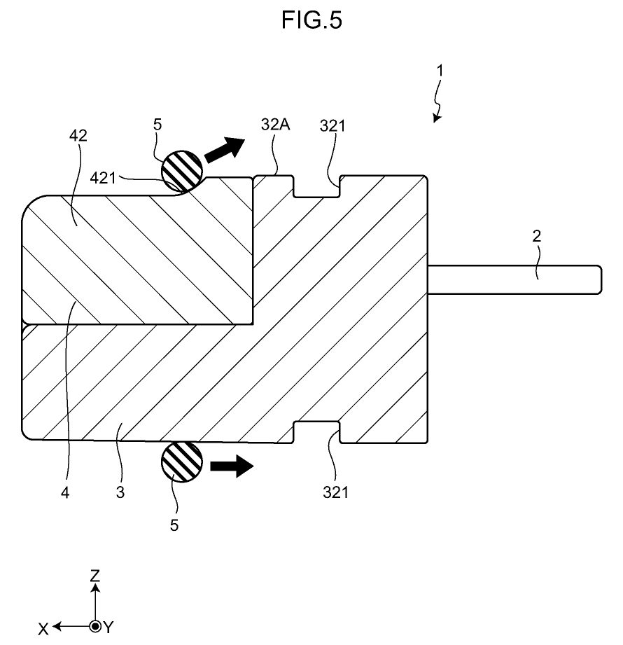

Then, the water stop member 5 is assembled to the housing 3 as illustrated in FIG. 5. The water stop member 5 is attached so as to surround the distal end side of the terminal support portion 32, is moved along the connection direction X toward the proximal end of the terminal support portion 32 in a state of being in contact with the terminal support portion 32 and the front holder 4, and is accommodated in the holding groove 321. At this time, the water stop member 5 is moved in contact with the end surfaces of the ribs 42, but can be easily assembled to the holding groove 321 since the inclined surfaces 421 are formed on the ribs 42. That is, the water stop member 5 is expanded in diameter by the inclined surfaces 421 when the water stop member 5 is attached to a distal end portion of the terminal support portion 32 and moves toward the proximal end, thereby being smoothly accommodated in the holding groove 321. In this case, the water stop member 5 can be assembled to the housing 3 without using a jig for accommodating the water stop member 5 in the holding groove 321. Then, when the water stop member 5 is assembled to the housing 3, the assembling of the terminal block 1 is completed.

As described above, in the terminal block 1 according to the present embodiment, the insulation property of the terminals 2 adjacent to each other can be secured by forming the rib 42 that divides the arrangement spaces 41 of the terminals 2 in the front holder 4. In addition, in the terminal block 1 according to the present embodiment, the inclined surface 421 is formed on the rib 42, and thus, the water stop member 5 can be easily assembled to the housing 3.

Incidentally, the terminal block according to the present invention is not limited to the above-described embodiment, and various modifications can be made within the scope described in the claims. The terminal block 1 according to the present embodiment may be configured by appropriately combining constituent elements of each of the embodiment and modifications described above.

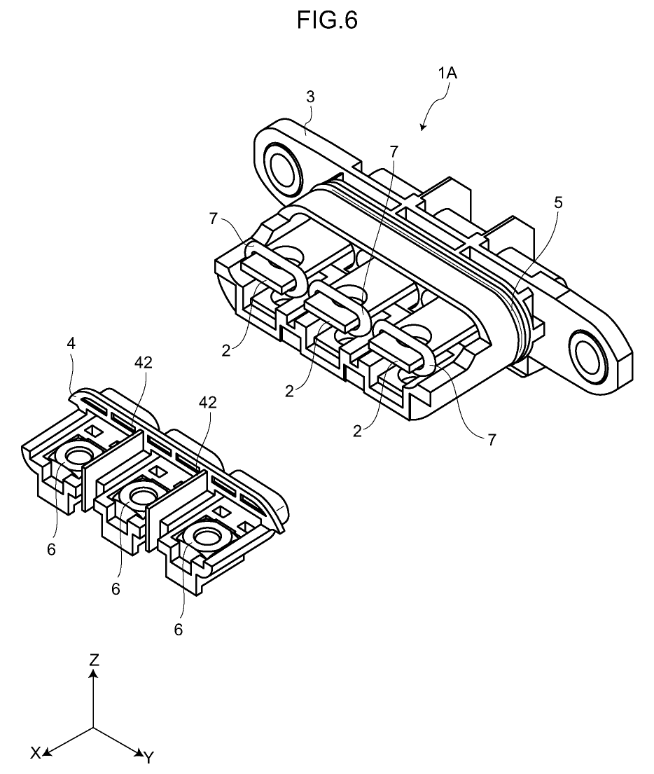

For example, in the terminal block 1 according to the above-described embodiment, a second water stop member 7 for stopping water may be provided between the terminals 2 and the housing 3 or the front holder 4. That is, as illustrated in FIG. 6, in a terminal block 1A, the second water stop member 7 is provided for each of the plurality of terminals 2. The second water stop member 7 is an annular packing surrounding the outer periphery of the terminal 2. The second water stop member 7 stops, for example, water between the housing 3 and the terminal 2. Also in the terminal block 1A, the ribs 42 are formed to ensure the insulation property between the terminals 2 adjacent to each other. Incidentally, the inclined surface 421 is not formed on the rib 42 of the terminal block 1A, but the inclined surface 421 may be formed. According to the terminal block 1A, the insulation property of the terminals 2 adjacent to each other can be secured by forming the rib 42 on the front holder 4 similarly to the terminal block 1 described above. In addition, in the terminal block 1A, the water stop member 5 can be easily assembled to the housing 3 by forming the inclined surface 421 on the rib 42.

According to the terminal block of the present embodiment, the water stop member can be easily assembled.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a plurality of terminals arranged side by side;
a housing including a main body portion that holds the plurality of terminals penetrating the main body portion in a connection direction, and a terminal support portion that is provided continuously with the main body portion and extends in the connection direction;
a front holder that is assembled to the terminal support portion and supports ends of the plurality of terminals; and
a water stop member that is assembled to an outer periphery of the terminal support portion and stops water at a water stop surface of the terminal support portion, wherein
the front holder includes ribs that are assembled to the terminal support portion on a distal end side of an assembly position of the water stop member and divide arrangement spaces of the plurality of terminals, and
the ribs are formed by being raised from a side of arrangement positions of the terminals toward the water stop surface of the terminal support portion, and have inclined surfaces inclined from the arrangement positions of the plurality of terminals toward the water stop surface of the water stop member.
